(19) United States
(12) Patent Application Publication
(10) Pub. No.: US 2023/0388194 A1
(43) Pub. Date: Nov. 30, 2023

(54) SOFTWARE-BASED PHYSICAL LAYER CONFIGURATION

(71) Applicant: Intel Corporation, Santa Clara, CA (US)

(72) Inventors: Nishant S. Shah, Portland, OR (US); K. Andrew Lillie, Chandler, AZ (US); Venkatramanan Jayatheerthan, Bengaluru (IN); Siddaraju D H, Bangalore (IN)

(73) Assignee: Intel Corporation, Santa Clara, CA (US)

(21) Appl. No.: 18/323,812

(22) Filed: May 25, 2023

(51) Int. Cl. H04L 41/122

(52) U.S. Cl. CPC H04L 41/122

(57) ABSTRACT

A software-based physical layer (PHY) management application is to configure a physical layer of a link through calls to an application programming interface (API) to send commands to firmware of a media access controller or internal PHY hardware of a platform. The commands to the firmware are to direct configuration of the physical layer of a link through the firmware, where the API abstracts functions of the controller and/or PHY hardware used to configure the physical layer of the link.

### FIELD

The present disclosure relates in general to the field of distributed computing systems, and more specifically, to physical layer interconnect configuration.

### BACKGROUND

A datacenter may include one or more platforms each comprising at least one processor and associated memory modules. Each platform of the datacenter may facilitate the performance of any suitable number of processes associated with various applications running on the platform. These processes may be performed by the processors and other associated logic of the platforms. Each platform may additionally include I/O controllers, such as network adapter devices, which may be used to send and receive data on a network for use by the various applications.

### BRIEF DESCRIPTION OF THE DRAWINGS

FIG. 1 illustrates a block diagram of components of a datacenter in accordance with certain embodiments.

FIG. 2 is a simplified block diagram of an example platform within a network.

FIG. 3 is a simplified block diagram illustrating an example processor device.

FIG. 4 is a simplified flow diagram illustrating an example technique to bring up a link.

FIG. 5 is a simplified block diagram illustrating an example implementation of a system on chip (SoC) coupled to external physical layer (PHY) devices.

FIG. 6 is a simplified block diagram illustrating an example SoC platform.

FIG. 7 is a flow diagram illustrating example use of a PHY management application.

FIG. 8 illustrates a block diagram of an example processor device in accordance with certain embodiments.

Like reference numbers and designations in the various drawings indicate like elements.

### DETAILED DESCRIPTION

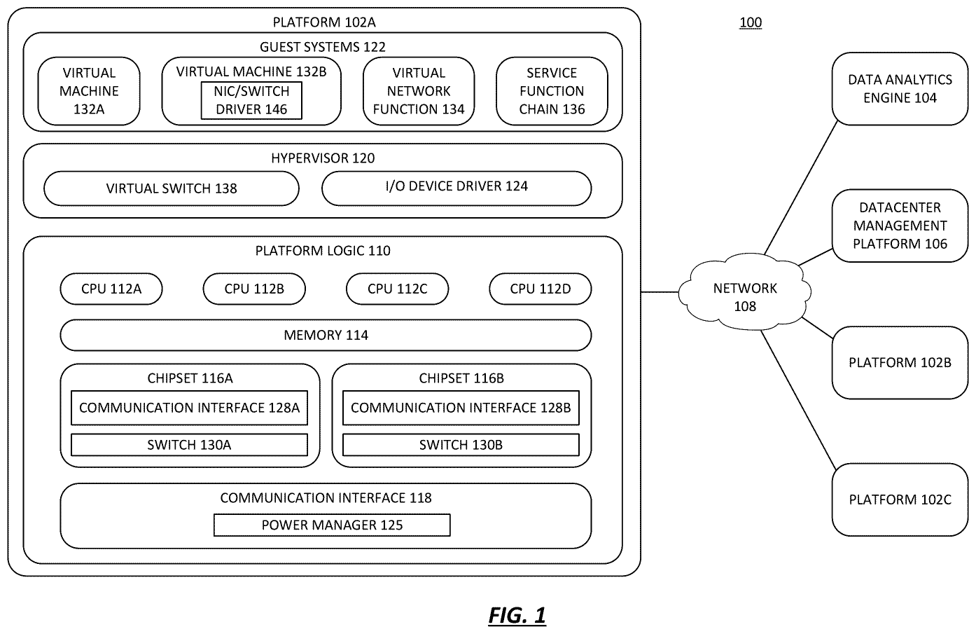

FIG. 1 illustrates a block diagram of components of a datacenter 100 in accordance with certain embodiments. In the embodiment depicted, datacenter 100 includes a plurality of platforms 102, data analytics engine 104, and datacenter management platform 106 coupled together through network 108. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications. The platform may be logically or physically subdivided into clusters and these clusters may be enhanced through specialized networking accelerators and the use of Compute Express Link (CXL) memory semantics to make such cluster more efficient, among other example enhancements.

Each platform 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compossible servers, disaggregated servers, or other suitable structures that comprises multiple platforms coupled together through network 108 (which may comprise, e.g., a rack or backplane switch).

CPUs 112 may each comprise any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removeably coupled to platform 102. Although four CPUs are shown, a platform 102 may include any suitable number of CPUs. In some implementations, application to be executed using the CPU (or other processors) may include physical layer management applications, which may enable customized software-based configuration of the physical layer of one or more interconnect used to couple the CPU (or related processor devices) to one or more other devices in a data center system.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may each comprise memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chipsets 116 comprising any suitable logic to support the operation of the CPUs 112. In various embodiments, chipset 116 may reside on the same package as a CPU 112 or on one or more different packages. Each chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated 110 controllers resident on each CPU.

Chipsets 116 may each include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (i.e., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, and others, which may each alternatively or collectively apply the general principles and/or specific features discussed herein. Switch 130 may be a physical or virtual (i.e., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is group of VNFs 134 organized as a chain to perform a series of operations, such as network packet processing operations. Service function chaining may provide the ability to define an ordered list of network services (e.g., firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (i.e., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. Each platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniB and, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports).

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the data system 100 may be coupled together in any suitable, manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

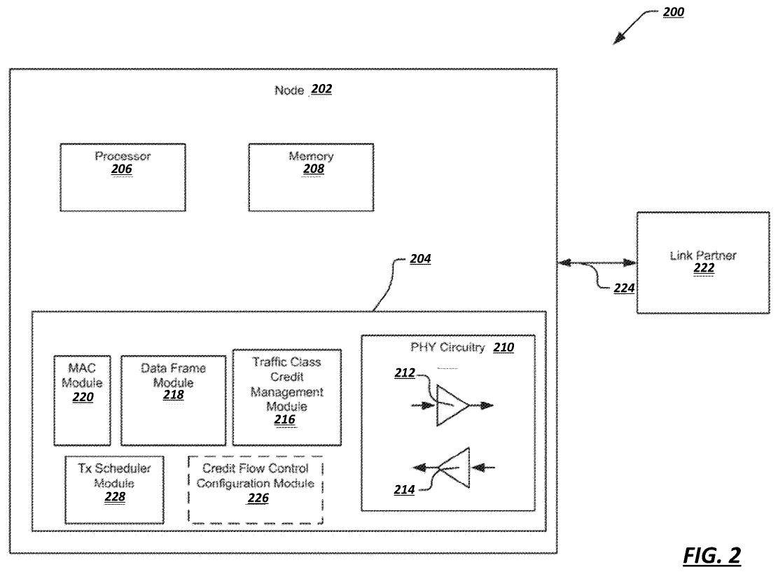

FIG. 2 is a simplified block diagram illustrating an example platform or node within a network (e.g., of a datacenter). FIG. 2 illustrates an example network system 200 consistent with various embodiments of the present disclosure. Network system 200 generally includes at least one network node element 202 and at least one link partner 222, each configured to communicate with one another via communications link 224. The node 202 and link partner 222 may form part of a network fabric, such as a network fabric within a server, a system on chip (SoC), data center, or other platform. The network node element 202 and the link partner 222 may communicate with each other, via link 224, using, for example, an Ethernet communications protocol. The Ethernet communications protocol may be capable of providing communication for other upper layer protocols such as, for example, Transmission Control Protocol/Internet Protocol (TCP/IP), User Datagram Protocol (UDP), Stream Control Transmission Protocol (SCTP), etc. The Ethernet protocol may comply with or be compatible with the Ethernet standard published by the Institute of Electrical and Electronics Engineers (IEEE) titled “IEEE 802.3 Standard,” and/or later versions of this standard, for example, the IEEE 802.3 Standard for Ethernet. In other embodiments, the network node element 202 and the link partner 222 may communicate with each other, via link 224, using, for example, a custom and/or proprietary communications protocol, such as that described in at least one embodiment herein. The link partner 222 and/or node element 202 may represent a computer node element (e.g., host server system, laptop, tablet, workstation, etc.), switch, router, hub, network storage device, network attached device, non-volatile memory (NVM) storage device, etc. The node 202 includes a network controller 204 (e.g., network interface card (NIC), etc.), a system processor 206 (e.g., multi-core general purpose processor) and system memory 208. The link partner 222 may be configured and operate in a similar manner as the node 202, as described in greater detail below.

The network controller 204 includes PHY circuitry 210 generally configured to interface the node 202 with the link partner 222, via communications link 224. PHY circuitry 210 may comply with or be compatible with, the aforementioned IEEE 802.3 Ethernet communications protocol, which may include, for example, 10 GBASE-T, 10 GBASE-KR, 40 GBASE-KR4, 40 GBASE-CR4, 100 GBASE-CR10, 100 GBASE-CR4, 100 GBASE-KR4, and/or 100 GBASE-KP4 and/or other PHY circuitry that is compliant with the aforementioned IEEE 802.3 Ethernet communications protocol and/or compliant with an after-developed communications protocol. PHY circuitry 210 includes transmit circuitry (Tx) 212 configured to transmit data packets and/or frames to the link partner 222, via link 224, and receive circuitry (Rx) 214 configured to receive data packets and/or frames from the link partner 222, via link 224. Of course, PHY circuitry 210 may also include encoding/decoding circuitry (not shown) configured to perform analog-to-digital and digital-to-analog conversion, encoding and decoding of data, analog parasitic cancellation (for example, cross talk cancellation), and recovery of received data. Rx circuitry 214 may include phase lock loop circuitry (PLL, not shown) configured to coordinate timing of data reception from the link partner 222. The communications link 224 may comprise, for example, a media dependent interface that may include, for example, copper twin-axial cable, backplane traces on a printed circuit board, fiber optic cable, copper twisted pair cable, etc. In some embodiments, the communications link 224 may include a plurality of logical and/or physical channels (e.g., differential pair channels) that provide separate connections between, for example, the Tx and Rx 212/214 of the node 202 and an Rx and Tx, respectively, of the link partner 222.

Ethernet system link establishment and diagnostics is a process by which an Ethernet Link is defined and brought up between two endpoints. Respective ports on each of the endpoint devices may include protocol logic (e.g., implemented in hardware circuitry), which is to be configured to perform various link training, equalization, and signal conditioning operations to bring the link up from an inactive state to an active state. Protocols such as Ethernet autonegotiation may be utilized, for instance, in connection with the link establishment to determine the maximum transmission speeds that each link partner, or endpoint device, supports, what port modes each device supports, whether they can operate in full or half duplex mode, whether the endpoints each support flow control mechanisms, etc. Indeed, Ethernet has defined and/or enabled a wide variety of different physical layer configurations, media types, and port modes, which may be utilized in various Ethernet links and subsystems. This is demonstrated, for instance, by Ethernet naming conventions, where port modes may be named according to the nominal, usable top speed of the PHY (e.g., 10, 1000, 1000, 10G, etc.), whether baseband, broadband, or passband signaling is used (e.g., BASE, BROAD, PASS), the media technology used (e.g., T=twisted pair, B=bidirectional fiber, P=passive optical, etc.), the encoding framework used, and the number of lanes used per link (e.g., “100BASE-BX10” designates 100 Mbit/s Ethernet bidirectionally over a single strand of single-mode optical fiber up to 10 km in length at full-duplex, among other Ethernet PHY examples).

Faults may occur during the link bring up and the endpoints may attempt to resolve such faults to successfully bring up the link. Additionally, faults may occur once a link has been brought up and is an active data transmitting state. Some of these faults may be due to incorrect or inadequate configuration of the physical layer (and related PHY logic on device ports). Likewise, diagnostics may be utilized to detect the nature of the faults and attempt to remedy faults, which may occur to ensure that links operate in a reliable fashion. Further, in some implementations, a complete end-to-end Ethernet Link that couples two endpoint devices (e.g., two SoC devices, a host SoC to an auxiliary endpoint device (e.g., an accelerator, ASIC, memory device, etc.), and so on) may include one or more intermediate active silicon devices or physical layer (PHY) devices on the link and positioned between the two endpoint devices of the link. As with ports on the endpoint devices, ports of the intermediate devices (e.g., both upstream and downstream ports of an intermediate device) are also to be configured and respective link segments brought up based on conditions such as the attached media used for the link/link segment and protocol mode for the application, among other example features. The principles discussed here apply to Ethernet and other networking and fabric protocols.

Traditional systems manage their respective Ethernet subsystem using entirely hardware and/or firmware-based controllers. For instance, in such implementations, the controller and/or internal PHY firmware takes full control of the hardware configuration and status monitor in connection with the establishment of an Ethernet link. Such traditional solutions may introduce issues for modern system architectures and designers. For instance, an all-hardware-based link establishment solution does not enable sufficient flexibility to modify the link topology when external devices and media are introduced beyond what the hardware was designed to support. While an all firmware-based link establishment solution can be adapted for different requirements, the development and validation of specialized firmware-based modules is nonetheless an expensive and slow process due to development and validation times. Often firmware is also updated for security purposes. Additionally, a firmware-based solution for communicating with external physical layer (PHY) blocks and devices can be slow and non-deterministic which may make it difficult to read time stamp (e.g., IEEE 1588 v2/PTP) information from these external devices, which may be critical in time sensitive communication applications, among other example issues.

As noted above, traditional firmware- and hardware-based solutions do not allow fast customizations and updates by the customer based on changes in their system design and components. Software-based control may be more aligned with differentiating the capabilities of different platforms in a product family. Further, firmware- and hardware-based solutions are generally inflexible towards the addition of new components on a deployed platform, such as changes or additions to the platform that may be made either in the field or during manufacturing (e.g., external PHY OCP modules or active components such as QSFP or SFP modules).

In order to provide a more flexible and customizable solution for managing Ethernet link establishment, software-based approaches may be explored, however, software-based link establishment may require that the software author understand detailed information about the array of lower level PHY devices and PHY functions used to query and configure a potentially diverse array of PHY devices and establish an end-to-end link. This level of detail may be difficult to correctly communicate and keep updated. Moreover, in some instances, software-based link establishment may run afoul of security policies and requirements of the system, among other example issues. In addition, traditional solutions do not provide diagnostic visibility and control of the physical layer from the application layer. Instead, for diagnostics, customers generally are forced to employ a separate diagnostics driver, which is not practical for infield debug scenarios. Further, software-based solutions typically utilize a separate software stack for manufacturing testing and production testing, which may not be desirable to maintain quality of the systems, among other example issues.

While traditional systems may rely on hardware- and firmware-based link establishment solutions, as the number of PHY types supported per product grows seemingly exponentially in complexity, system and application implementers are demanding more control of link management and configuration at the application level. For instance, a system or application designer may desire to be able to fully configure various platforms, which may include diverse and even proprietary PHY blocks and PHY media elements using their applications, rather than depending on the development, validation, release, and delivery of firmware components to implement such subsystems. In some implementations, an improved system may be provided with one or more application programming interface(s) (APIs) through which application layer software controllers may make defined calls (provided in the API) to a media access controller (or, simply, “controller”) firmware and/or internal PHY firmware (e.g., through a corresponding driver) to implement software-based configuration of the local PHY. The set of abstracted APIs may be provided to the application layer for physical layer configuration and diagnostics. Such APIs may represent a common set of APIs which may be equally used at the application layer level, kernel level, as well in any Data Plane Development Kit (DPDK) application, among other examples. Accordingly, the application can utilize the API to choose the appropriate access mechanism and own the Ethernet subsystem configuration or diagnostics. Additionally, the API may also define commands to enable software to interface with a management interface coupled to external PHY devices in the system, to enable software to query characteristics of the external PHY devices and communicate commands to control configuration of link segments implemented using the external PHY devices, among other example features. For instance, the controller driver may contain APIs to the management interface and the APIs for software-based PHY configuration may expose these driver-management interface APIs to a PHY management application, among other example implementations. In some implementations, the API may be implemented through a defined software development kit (SDK), which leverages a standardized firmware (e.g., at the controller and/or internal PHY), allowing only higher level PHY configuration details to be defined in a software-based Ethernet subsystem controller. The SDK, through the standardized firmware, may abstract as much low level PHY configuration information as possible at the firmware level vastly simplifying and genericizing the calls that are defined in software. In some implementations, the API may also provide for direct software-to-hardware interaction for time sensitive operations, among other example features.

In some implementations, an Ethernet subsystem may be managed by a software-based controller utilizing a standardized API, such as discussed herein. Such a software-based approach may enable system designers to flexibly control and modify how, what, and when Ethernet links are enabled and ensure that they are quickly and seamlessly established even in the presence of diverse external PHY devices. Further, an API may be defined to interoperate with and communicate with particular firmware (e.g., of the controller and/or internal PHY), and this firmware (e.g., a single FW image) may be implemented in a variety of platform configurations on a design, eliminating the overall system integration complexity and in-field firmware management. Further, a software-based approach may solve variable latency concerns related to controlling external devices through internal firmware by providing a more deterministic path from software to the external hardware that is independent of internal firmware. Further, the debug and testing of the system may be accelerated with the use of the software layer with good correlation to the mission-mode operation. Given the relative ease in developing, deploying, and fine-tuning software, a software-based approach may generally allow users to design modular Ethernet platforms to unlock additional economical value, among other example advantages.

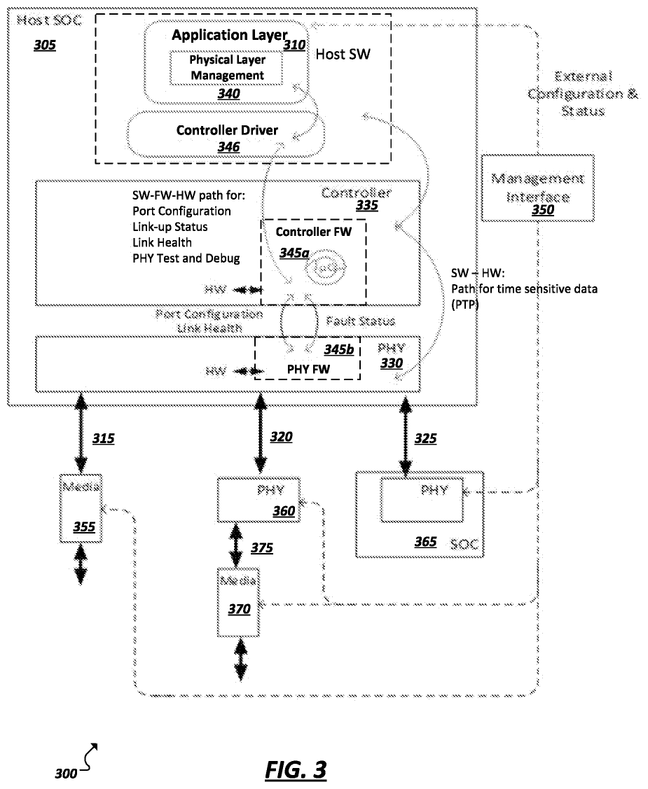

FIG. 3 is a simplified block diagram 300 illustrating an example processor device 305, such as a host system on chip (SoC), which includes one or more processing cores to execute code and implement one or more applications, services, and microservices (e.g., in an application layer 310 of the processor device 305 or platform). The processor device 305 may include one or more ports to couple to other endpoint device link partners over corresponding links according to one or more protocols. In one example, the processor 305 device may couple to multiple different link partner devices via corresponding Ethernet link segments (e.g., 315, 320, 325, etc.). The ports may each implement respective protocol stacks, with physical layer (PHY) hardware (e.g., 330) utilized to support one or more Ethernet port modes and one or more media types. Media access controller (MAC), or simply controller, hardware 335 may be provided to interface with the PHY hardware 330 and implement one or more additional layers of the protocol stack (e.g., a data link layer) and/or facilitate an interface between the physical layer and upper layers of the protocol stack.

In the example of FIG. 3, software-based or application-layer-level control of link bring-up may be provided in the processor device 305. For instance, a physical layer management application 340 may be executed in the application layer 310 and may be developed in accordance with a software development kit (SDK), which simplifies development of the application 340 using one or more defined APIs configured to interoperate with firmware (e.g., 345a-b) of the controller 335 and/or internal PHY 330 of the processor device. For instance, the application 340 may make use of API calls (e.g., through the driver(s) 346 for controller 335 and the internal PHY 330) to direct the firmware 345a-b of controller 335 and/or internal PHY 330 to generate signals to perform various configuration, link training, or other link bring-up operations. Further, the physical layer management application 340 may utilize the APIs to query, configure and manage each of the PHY components (e.g., both the internal PHY 330 and the external PHY devices (e.g., 355, 360, 365, 370) to establish Ethernet connectivity. The abstraction provided through the APIs allow simplification and optimized configuration for the software-based physical layer management application 340 and eases platform support requirements, among other example advantages.

At the lowest level the PHY layer is controlled by corresponding hardware registers (e.g., defining and/or governing the capabilities of each PHY block and the configuration(s) to be applied to each block). These hardware registers may be used to program the various functions implemented in the PHY hardware to establish electrical communications. The PHY firmware may be implemented to abstract these hardware control and status functions to operations that can be used, for instance, by the Ethernet controller 335 to request the use of various Ethernet port modes to be supported using the PHY lanes. PHY firmware may also abstract the communication of port status information. For instance, link status information such as “link-up” or “link down” and “fault status” may be communicated with a hardware interface between the PHY 330 and the controller 335 (e.g., because it is a time sensitive function). “Link-up” is finally determined by the controller itself based on information from the local PHY (“fault status”) and the data received from the link partner PHY, among other examples. The controller 335 uses its own firmware 345a to configure itself and the PHY 330 for the correct port mode assignments based on commands received from software commands from the application 340. The controller benefits from the use of the abstraction in the firmware-based controller-PHY interface. As communication at this level in the controller does not rely on understanding of the low-level details and functionality of the PHY 330, it may communicate the specific port mode that is to be used and some parameters for functions of that port mode. The controller firmware 345a may have functions to configure the controller 335 itself to match the determined port mode assignments with the data paths and functions in the controller. The controller firmware 345a may also define firmware functions that can be called through administration commands from the software driver 346 and application layers above to configure and get status from the Ethernet sub-system implemented through the controller 335 and internal PHY 330.

The physical layer management application 340, in the example of FIG. 3, may function as the administration center for all of the Ethernet links on the platform. While the example of FIG. 3 refers to an SoC-integrated Ethernet platform, it should be appreciated that the principles discussed herein may also be applied to other platform types (e.g., LAN-based Ethernet, motherboard-based Ethernet, etc.). The physical layer management application 340 directs the control of the establishment and configuration of the Ethernet links (e.g., 315, 320, 325, 375, etc.) and has full visibility into all of the Ethernet components (e.g., 330, 355, 360, 365, 370, etc.) on the platform. The physical layer management application 340 configures the controller 335 and internal PHY 330 in the host SOC via the controller firmware 345a using driver 346 and controller firmware administration commands defined through the SDK API. Based on the commands received from the physical layer management application 340, the controller 335 can then configure the internal PHY 330 using abstracted firmware commands (e.g., from the controller firmware 345a to the internal PHY firmware 345b) to harmonize the internal PHY's configuration with the controller configuration set using the physical layer management application 340. For instance, the physical layer management application 340 may be utilized to configure the local internal PHY's equalization such that the interface meets stringent electrical I/O characteristics based on the selected port mode (e.g., in accordance with IEEE802.3 and SFF8431 MSA).

In the example of FIG. 3, an Ethernet platform architecture is implemented and coupled to various external devices (e.g., 355, 360, 365, 370, etc.), including media interfaces 355, 370 (e.g., an electrical-to-optical conversion device), external PHY devices 360 (e.g., PHY IP blocks), a link partner SoC 365, extension devices (e.g., retimer devices), among other examples. The external PHY devices may be utilized to facilitate a connection between the processor device and another endpoint/link partner device. Additionally, in some implementations, such as with a link partner SoC 365, some link partner devices may also include application layer-based PHY link management (e.g., using another instance of the same controller firmware image and PHY SDK), which may operate on the other end of the link to assist in establishing and configuring the link at the link partner device. When the platform includes such external components in the Ethernet link topology the link segments coupling these external components are also subject to configuration, which may also be controlled by the physical layer management application 340. For instance, when media can be attached via a connector receptacle device (e.g., 355), the media type and capability information of the external component can determine the rest of the link topology on the platform. Sideband or control signaling interfaces may be provided at the external devices (e.g., 355, 360, 365, 370). The Ethernet platform, in some implementations, may include a management interface device 350, which may be utilized to facilitate signaling and communication with the external devices 355, 360, 365, 370, etc. (e.g., through I2C and/or Management Data Input/Output (MDIO) interface signaling) to facilitate management and status checks of external PHY devices in the system. The physical layer management application 340 may utilize a defined API to query media, support port modes, status information, and other information of the external PHY devices (e.g., 355, 360, 365, 370) via the management interface 350. For instance, the management interface 350 may be used to translate SoC external bus messages (such as from a system management bus (e.g., MDIO bus, I2C bus, etc.) to interface protocols that support the external Ethernet link components such as retimers, external PHYs, and media modules. These messages may originate in the application layer at the physical layer management application 340 and be passed to the management interface via software drivers and/or firmware to the management interface's hardware pins. Such an approach may provide flexibility to the system designer for the choice of external devices and how they should be configured using these messages. In some implementations, a direct hardware interface may be provided to enable the physical layer management application 340 to address and configure the external components (via the management interface) in a fast deterministic manner for time critical applications, among other example features.

Through communication with a management interface 350, a physical layer management application 340 may monitor status and receive diagnostic information pertaining to connected external PHY devices (e.g., 355, 360, 365, 370). For instance, fault status information may be pushed to the physical layer management application 340 and indicate whether a fault is a “local fault” (e.g., pertaining to the local internal PHY) or “remote fault” (e.g., pertaining to a link segment (e.g., 375) coupled to one or more of the external PHY devices (e.g., 360, 370). Additional information can be obtained by the physical layer management application through the management interface 350 to identify the specific link segment involved in a fault and logic of the physical layer management application 340 can determine a remedy for the fault and send commands to the internal Ethernet subsystem or to external PHY devices to reconfigure, retrain, or otherwise remedy the fault.

Utilizing a physical layer management application 340 in the application layer to govern the establishment of Ethernet links in a platform may enable a single firmware and software image to be reused across various application platforms that could connect to different types of external devices and link partners and thus involve a variety of different equalization settings per port. This differs from traditional implementations, where system designers, during design time, needed to identify, ex ante, the specific nature of the links, external PHY devices, and link partner devices that would couple to a platform and build controller and/or PHY firmware images specific to the anticipated platform deployment. Instead, utilizing a standardized SDK and API and corresponding controller firmware image, the same firmware image may be reused across various platforms, with respective physical layer management application implementations programmed to the specific PHY design (e.g., port modes, media, external PHY combinations, etc.), rather than developing a design- and validation-intensive firmware solution specific to the platform design.

Further, application layer control of an Ethernet subsystem through an Ethernet PHY SDK allows the leveraging of controller and/or PHY firmware to abstract low level hardware functionality such that the software (e.g., physical layer management application 340) used to configure the link can be simplified. Debug and testing can also leverage this approach enabling the physical layer management application 340 to perform test functions using the same path through the firmware for test. Debug information may be provided to the physical layer management application 340 based on fault information passed from the PHY 330 to the controller 335 on their shared HW interface. For instance, controller firmware 345a may present the fault indication to the software via its firmware administration status messages, among other examples.

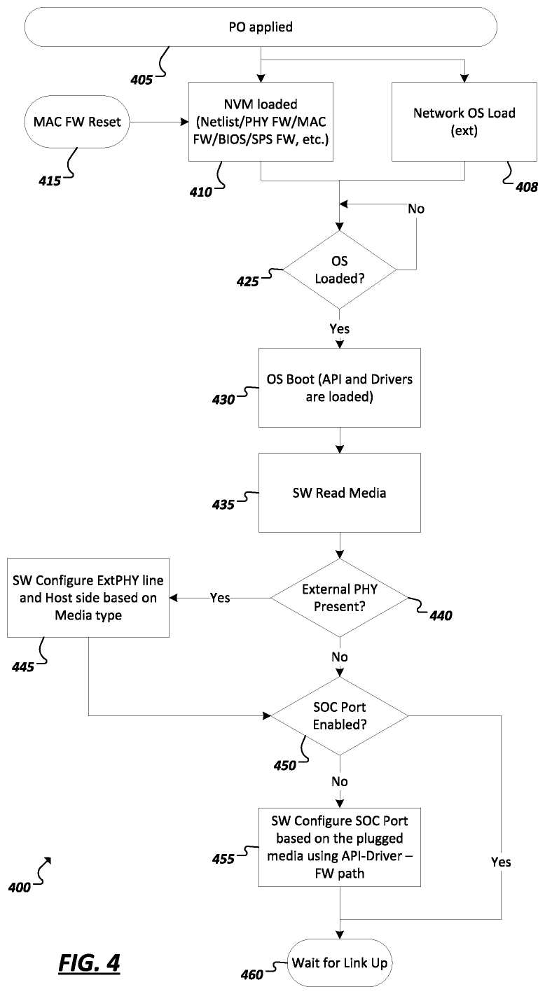

Turning to the flow diagram 400 of FIG. 4, an example flow is illustrated from the power-on of a platform to operating system (OS) load to network topology detection configuration for link establishment of links under the direction of an application layer-implemented physical layer management application to offer detailed debug and configuration flexibility, such as discussed above. The platform power-on (PO) may be applied 405 and the host processor's operating system may be loaded 408 as well as the basic controller and internal PHY capabilities (e.g., from non-volatile memory (NVM)) (at 410) at power-on together with a reset 415 of the controller firmware. The local internal PHY may be configured for a port disable state to allow the port(s) to be initiated as and when desired at the desired speed(s) at the control and direction of the software-based physical layer management application. The disabled state may still have a comprehension of the port capabilities as defined in the basic PHY NVM, among other examples.

The platform may load 425 and boot 430 the operating system (OS), together with the application layer Ethernet PHY SDK APIs and drivers to be used by the physical layer management application. The physical layer management application may be loaded and may utilize API calls to read 435 information describing the connected media to be used by the ports as well as the presence of any connected external PHY devices used to facilitate the media type or the links more generally. Based on this information, logic of the physical layer management application may determine what configurations to apply at the internal PHY to enable links to be successfully brought up that connect to and use the connected media and external PHY devices. For instance, attributes such as port mode, supported speeds, media type, etc. of the external devices may drive what configurations should be set at the internal PHY to enable the links to be brought up and function successfully.

The physical layer management application may also identify 440 whether any external PHY devices are coupled to ports of the host device and configure 445 the external PHY devices (e.g., through a system management bus and/or a management interface element), as well as the host side ports based on the detected attributes. The physical layer management application may cause the SoC port to be enabled 450 (e.g., to handle the case where an external PHY/media module may be connected to the port pins, but the SoC has not yet enabled that port for use at the SoC level (e.g., in the integrated PHY)). The SOC's integrated ports may then be configured 455 based on what is discovered to be connected to the port and/or the operating mode of a connected external PHY port, among other examples. In some instances, the internal SoC PHY port has to wait until the external PHY port has identified a compatible operating mode, then the internal port is configured to match. The physical layer management application may configure the host port using an API-driver-controller firmware path based on the detected attributes and types of external devices connected to the host ports. For instance, the physical layer management application may read capabilities of the internal PHY port(s) and determine a best match to achieve connectivity with these external components, for instance, using a “get port capability” API function defined in the SDK. In response, the internal controller and/or PHY firmware may return a list of capabilities to the physical layer management application (e.g., 10G-KR, 25G-KR, 25G-AUI, etc.). Based on the commands and information provided by the physical layer management application to configure respective firmware and other logic of the internal PHY and any external PHY devices, protocol logic resident on the internal PHY and external PHY may apply these configurations to complete associated link bring up protocols and bring the link to an “up” or active state (at 460).

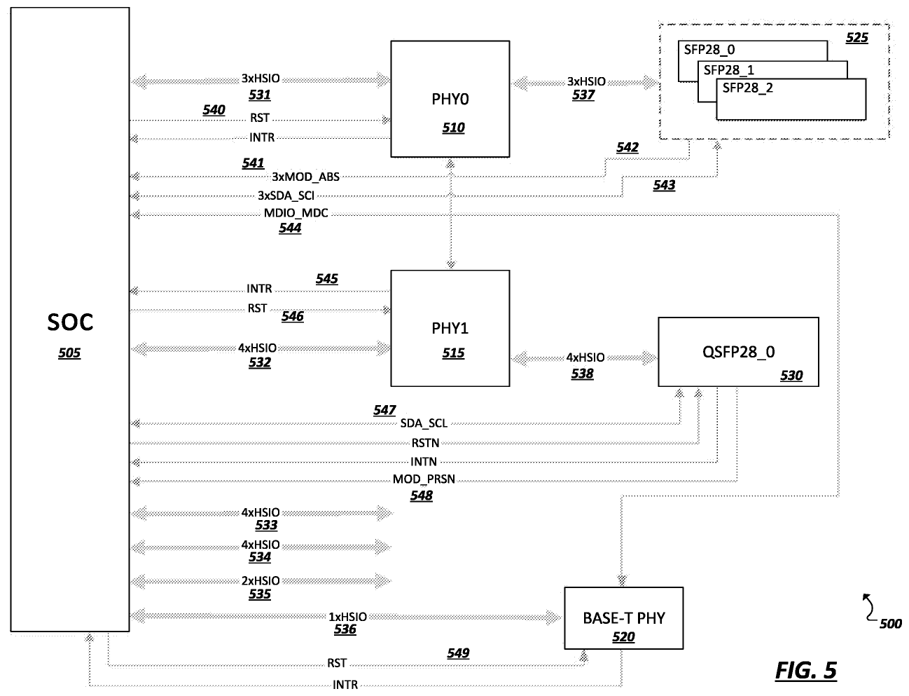

FIG. 5 is a simplified block diagram 500 illustrating an example implementation of an SOC 505 with SoC-integrated Ethernet and firmware compatible with an Ethernet PHY SDK that provides an API for the development of a physical layer management application written for the particular system implementation, which may include connections to external PHY devices 510, 515, 520, 525, 530. In addition to lanes (e.g., 531-538) used to facilitate the physical in-band data links, management bus lanes or other sideband lanes (e.g., 540-549, etc.) may be provided to couple the SoC (e.g., a management interface of the SoC) with external devices used in the platform to extend or otherwise implement end-to-end Ethernet links (to respective link partner endpoint devices). These management bus lanes (e.g., 540-549) may be utilized to facilitate push diagnostics to the physical layer management application using the Ethernet PHY SDK. For instance, after platform reset deasserts, the physical layer management application may configure the PHY subsystem using the PHY SDK and various (in-band) links are brought up (e.g., using the technique described in the example of FIG. 4). Should the link go down or encounter a fault, the PHY SDK diagnostics push mechanism may provide a list of parameters to the physical layer management application for processing using the physical layer management application to narrow down the root cause of PHY layer link interruption.

As an example, upon detection of a local fault on a platform with an external PHY device with SFP+ cages (e.g., 525), the fault can be detected by the physical layer management application and the physical layer management application can request a push diagnostics mechanism to extract data from the memory map of the external PHY device, such as the internal PHY receiver (Rx) state machine status, external PHY Rx and transmitter (Tx) state machine status, etc. In some instances, an external PHY device may alert the SoC (e.g., via a management bus) of an issue identified at the external PHY device (e.g., using an interrupt or other message communicated to the SoC via the management interface), which may prompt the physical layer management application to seek additional information (e.g., via the management interface). This information may be provided to the physical layer management application and the physical layer management application may process this data to generate an alert, report, or other information to a system administrator. In some implementations, a software-based diagnostics implementation provided through the SDK can be a tiered approach, where a first subset of parameters are pushed for coarse diagnostics information and a second set of parameters are pushed for granular diagnostics. In some implementations, the first and second set of parameters may be pushed in parallel, while in other implementations, the coarse diagnostics may be sent first, with more granular diagnostics sent in response to a query initiated by the PHY management application (e.g., after assessing the course diagnostics (e.g., which may be sent by the external PHY device upon identifying an issue at the external PHY)). Accordingly, a variety of different physical layer management applications may be developed with varying approaches and logic for diagnostics and troubleshooting (e.g., with some utilizing coarse and/or granular diagnostics in different ways and for different purposes, depending on the desires and designs for the system on which the physical layer management application is to be deployed), among other examples. Indeed, utilizing such a PHY SDK approach allows broad level of customization and diagnostics strategies for agile, software-based Ethernet PHY level implementation.

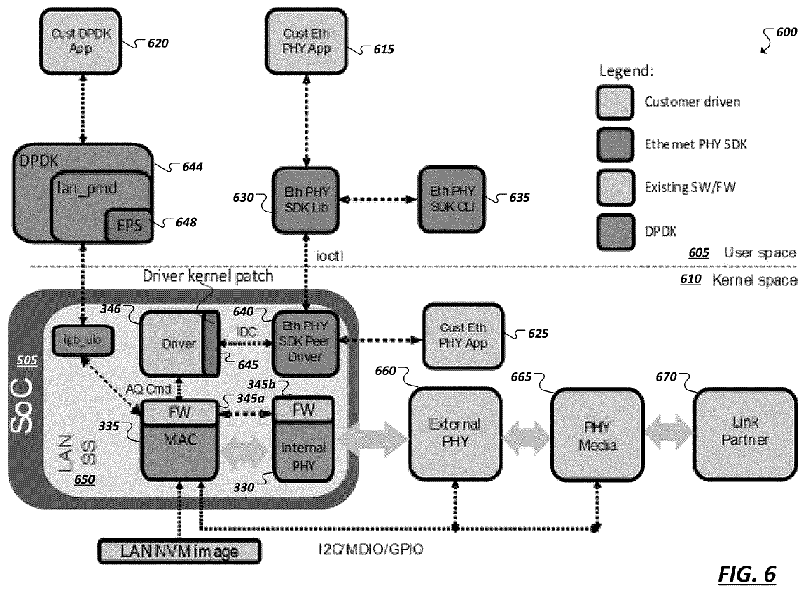

FIG. 6 is a simplified block diagram 600 illustrating an example SoC platform 505, including an example implementation of an Ethernet PHY SDK. The illustration of FIG. 6 differentiates between components that may be implemented in user space 605 versus those that may be implemented in kernel space 610. In this example, the networking subsystem 610 (e.g., an Ethernet subsystem) may include a controller 335 (e.g., a MAC) with associated firmware 345a, internal PHY hardware 330 with associated firmware 345b, and a driver 346 through which software may communicate with the subsystem 610. The firmware 345a-b may abstract controller and PHY functionality and be configured to be compatible with the Ethernet PHY SDK (e.g., by supporting calls to a set of operations, modes, and messages through APIs defined in the PHY SDK).

A variety of different software applications (e.g., 615, 620, 625, etc.) may be developed based on an example PHY SDK. An example PHY SDK can be embodied as a set of interoperating components, such as a PHY SDK library 630, PHY SDK command line interface (CLI) 635, and SDK kernel space driver 640. For instance, a custom Ethernet PHY management application 615 may be based on and make calls to a library 630 of the PHY SDK (e.g., through input-output control (IOCTL)), which defines abstracted calls which may be made to an Ethernet PHY SDK peer driver 640, which may access an PHY SDK command line interface (CLI) 635 (e.g., for use in development and debug) to interface with a driver kernel patch 645 added to driver 346 to cause configuration commands, query requests, and other information to be communicated (e.g., via admin queues commands (AQ Cmd)) to the controller firmware 345a. Ethernet PHY SDK Peer driver 640 provides device control/access interfaces to user-space application/libraries 630 (through input-output control (IOCTL)) and to other kernel driver modules/apps 625. Additionally, a kernel driver patch 642 may be provided on the driver 346 to enable inter driver communication (IDC) and implement functions to handle requests coming from peer-driver 640, among other example implementations.

In another example, a PHY management application 620 may be built upon a version of another development kit, such as DPDK 644. For instance, a DPDK poll mode driver (PMD) may be enhanced with calls or a sub-library (e.g., 648) defined in the PHY SDK to enable the PHY management application 640 to be built to control link establishment at the Ethernet subsystem 650. In still other examples, a kernel space PHY management application 625 may be developed, which may utilize a PHY SDK peer driver 635 to make calls, which will be translated to administrative commands of the controller firmware 345a, among other example implementations. In this manner, a system designer may not only select the various external PHY devices (e.g., 660, 665, 670) for use within the system, but may develop customized PHY management applications adapted to control such an Ethernet system, link bring up within the system, and diagnostics within the system, all using the same native Ethernet subsystem 650 and subsystem firmware 345a-b. PHY SDK APIs may be further written to be operating system independent and may be adapted to different environments. The PHY SDK may maintain any minimal state information based on the availability of obtaining current state from the lower modules (e.g., driver 346, firmware 345a, firmware 345b, etc.), for various different usages.

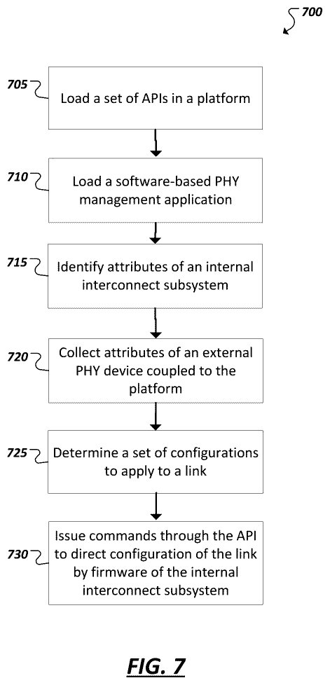

FIG. 7 is a simplified flow diagram 700 illustrating example use of a PHY management application, which utilizes a set of defined APIs to implement application layer control of an interconnect subsystem. The interconnect subsystem may include a controller with associated firmware (e.g., to implement one or more layers of an interconnect protocol above a physical layer) coupled to physical layer hardware with associated firmware. The physical layer may implement at least a portion of a port, which may be used to connect a system (e.g., an SoC) to another device over a physical link according to the interconnect protocol. The set of APIs may be loaded 705 including, in some implementations, additional components of a SDK, such as a command link interface, driver, etc. The PHY management application may be loaded 710 and may be written to call upon the set of APIs to interface with the firmware of one or both of the control firmware and/or PHY firmware, as well as potentially other system components, including components implement management and control communications for external PHY devices, such as a management interface. The APIs may abstract the specific functionality and details of the controller and PHY hardware, but may facilitate a library of calls that the PHY management application may use to collect information from the controller and/or PHY and to send commands to be carried out using the controller and/or internal PHY to complete desired configuration of the link in order to successfully bring up the link.

In one example, with the set of APIs and PHY management application loaded, the PHY management application may collect 715 information from the internal controller and/or PHY to determine the capabilities of the local interconnect subsystem. The set of APIs may be further used by the PHY management application to query and collect 720 information pertaining to any external PHY devices which may be included on links to which ports of the local interconnect subsystem are connected. The firmware of the local controller and/or hardware may not be natively configured to recognize or support the use of such external PHY devices. The PHY management application may function to direct the firmware to nonetheless configure the local PHY to support such links. Additionally, the set of APIs may constrain the involvement of the PHY management application software to use firmware-based communications (e.g., as defined in the firmware), so as to negate potential security vulnerabilities arising from an unrestrained software-based approach.

Based on the attributes of the local PHY and any external PHY devices collected by the PHY management application, the PHY management application may determine 725 a set of configurations to be employed at the local PHY and/or external PHY devices to enable the link segments of the link and corresponding ports to be properly configured (e.g., to successfully complete training, equalization, negotiation, etc.), including the port mode to be used for each link segment. Upon determining the desired configuration, the PHY management application may issue commands 730 via the set of APIs to direct, using local firmware, corresponding configuration of the local PHY and (e.g., using sideband control and management signals (e.g., I2C, MDIO, etc.)) likewise direct configuration of any external PHY devices to enable respective link segments to be properly brought up (e.g., based on each link segment's respective port mode and associated media) and enabling the end-to-end link to function reliably and in accordance with the corresponding interconnect protocol (e.g., Ethernet).

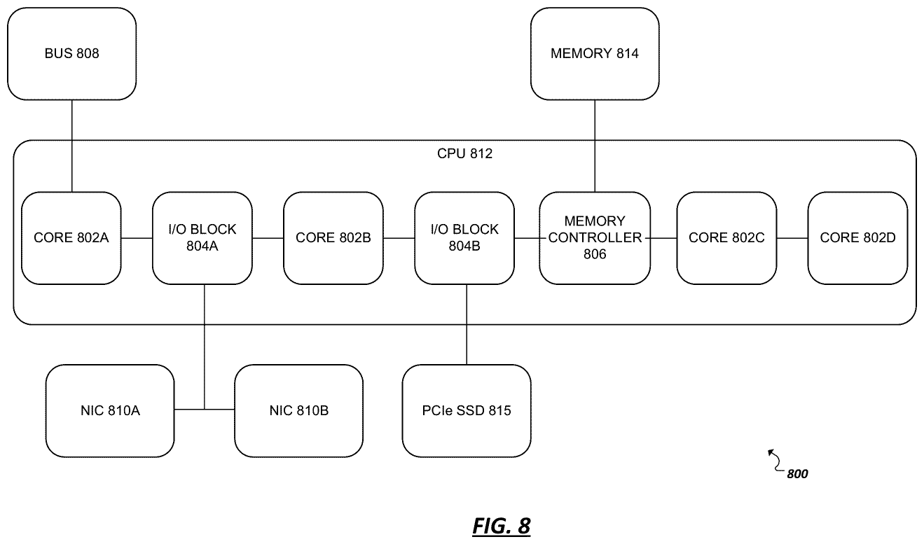

Note that the apparatus', methods', and systems described above may be implemented in any electronic device or system as aforementioned. As a specific illustration, FIG. 8 provides an exemplary implementation of a processing device such as one that may be included in a network processing device. It should be appreciated that other processor architectures may be provided to implement the functionality and processing of requests by an example network processing device, including the implementation of the example network processing device components and functionality discussed above. Further, while the examples discussed above focus on improvements to an Ethernet subsystem and links compliant with an Ethernet-based protocol, it should be appreciated that the principles discussed herein are protocol agnostic and may be applied to interconnects based on a variety of other technologies, such as PCIe, CXL, UCIe, CCIX, Infinity Fabric, among other examples.

Referring to FIG. 8, a block diagram 800 is shown of an example data processor device (e.g., a central processing unit (CPU)) 812 coupled to various other components of a platform in accordance with certain embodiments. Although CPU 812 depicts a particular configuration, the cores and other components of CPU 812 may be arranged in any suitable manner. CPU 812 may comprise any processor or processing device, such as a microprocessor, an embedded processor, a digital signal processor (DSP), a network processor, an application processor, a co-processor, a system on a chip (SOC), or other device to execute code. CPU 812, in the depicted embodiment, includes four processing elements (cores 802 in the depicted embodiment), which may include asymmetric processing elements or symmetric processing elements. However, CPU 812 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 812, as illustrated in FIG. 8, includes four cores—cores 802A, 802B, 802C, and 802D, though a CPU may include any suitable number of cores. Here, cores 802 may be considered symmetric cores. In another embodiment, cores may include one or more out-of-order processor cores or one or more in-order processor cores. However, cores 802 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 802 may include a decode module coupled to a fetch unit to decode fetched elements. Fetch logic, in one embodiment, includes individual sequencers associated with thread slots of cores 802. Usually a core 802 is associated with a first ISA, which defines/specifies instructions executable on core 802. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, as decoders may, in one embodiment, include logic designed or adapted to recognize specific instructions, such as transactional instructions. As a result of the recognition by the decoders, the architecture of core 802 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 802, in one embodiment, recognize the same ISA (or a subset thereof). Alternatively, in a heterogeneous core environment, a decoder of one or more cores (e.g., core 802B) may recognize a second ISA (either a subset of the first ISA or a distinct ISA).

In various embodiments, cores 802 may also include one or more arithmetic logic units (ALUs), floating point units (FPUs), caches, instruction pipelines, interrupt handling hardware, registers, or other suitable hardware to facilitate the operations of the cores 802.

Bus 808 may represent any suitable interconnect coupled to CPU 812. In one example, bus 808 may couple CPU 812 to another CPU of platform logic (e.g., via UPI). I/O blocks 804 represents interfacing logic to couple I/O devices 810 and 815 to cores of CPU 812. In various embodiments, an I/O block 804 may include an I/O controller that is integrated onto the same package as cores 802 or may simply include interfacing logic to couple to an I/O controller that is located off-chip. As one example, I/O blocks 804 may include PCIe interfacing logic. Similarly, memory controller 806 represents interfacing logic to couple memory 814 to cores of CPU 812. In various embodiments, memory controller 806 is integrated onto the same package as cores 802. In alternative embodiments, a memory controller could be located off chip.

As various examples, in the embodiment depicted, core 802A may have a relatively high bandwidth and lower latency to devices coupled to bus 808 (e.g., other CPUs 812) and to NICs 810, but a relatively low bandwidth and higher latency to memory 814 or core 802D. Core 802B may have relatively high bandwidths and low latency to both NICs 810 and PCIe solid state drive (SSD) 815 and moderate bandwidths and latencies to devices coupled to bus 808 and core 802D. Core 802C would have relatively high bandwidths and low latencies to memory 814 and core 802D. Finally, core 802D would have a relatively high bandwidth and low latency to core 802C, but relatively low bandwidths and high latencies to NICs 810, core 802A, and devices coupled to bus 808.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: a processor; physical layer (PHY) hardware, where the physical layer hardware includes circuitry to implement at least a portion of a link; a media access controller block, where the media access controller block includes controller firmware and controller hardware, where the controller hardware is to interface with the PHY hardware to establish the link; and PHY management software, executable by the processor, to configure a physical layer of the link, where the PHY management software is to call on an application programming interface (API) to send commands to the controller firmware and direct configuration of the physical layer of the link via the controller firmware, where the API abstracts functions of the controller firmware to be used to configure the physical layer of the link.

Example 2 includes the subject matter of example 1, where the PHY management software is to direct configuration of a local port implemented by the PHY hardware local port.

Example 3 includes the subject matter of example 2, where the PHY management software is to identify attributes of an external PHY device coupled to the apparatus by the local port, where the external PHY device facilitates a connection with a link partner device over the link and is positioned between the local port and the link partner device on the link.

Example 4 includes the subject matter of example 3, where the external PHY device includes a retimer.

Example 5 includes the subject matter of example 3, where the external PHY device includes a media module to transition from a first media used in a link segment to couple the local port to the external PHY device and a second media used in a second link segment to couple the external PHY device to the link partner device.

Example 6 includes the subject matter of example 3, where the external PHY device supports a particular port mode not supported by the PHY hardware and facilitates use of the particular port mode on the link.

Example 7 includes the subject matter of any one of examples 3-6, where the PHY management software directs configuration of the local port based on the attributes of the external PHY device.

Example 8 includes the subject matter of any one of examples 3-7, where the PHY management software is to further use the API to direct configuration of one or more ports of the external PHY device.

Example 9 includes the subject matter of any one of examples 3-8, where the attributes of the external PHY device include at least one of a type of the external PHY device, port modes supported by the external PHY device, or a media used by the external PHY device.

Example 10 includes the subject matter of example 3, where the PHY management application is further executable to: receive fault information for the link, where the fault information includes information associated with the external PHY device; and identify, from the fault information, a link segment of the link associated with the fault.

Example 11 includes the subject matter of example 1, where configuration of the physical layer of the link includes equalization of one or more ports used to establish the link.

Example 12 includes the subject matter of any one of examples 1-11, where the API is associated with a software development kit (SDK), and the PHY management application is written based on the SDK.

Example 13 includes the subject matter of example 12, where the SDK enables development of a plurality of different PHY management applications to interoperate with respective instances of the controller firmware.

Example 14 includes the subject matter of any one of examples 1-13, where the link is to be established based on an Ethernet-based protocol.

Example 15 is a non-transitory machine readable medium with instructions stored thereon, the instructions executable by a machine to cause the machine to: load a set of application programming interfaces (APIs) for management a physical layer of an Ethernet subsystem, where the Ethernet subsystem includes a local physical layer (PHY) hardware block to implement a port and a media access controller (MAC) block, where the MAC block includes MAC hardware and MAC firmware; load a PHY management application in an application layer, where the PHY management application is to use the set of APIs; determine, using the PHY management application, that an external physical layer (PHY) device is coupled to the Ethernet subsystem; determine, using the PHY management application, capabilities of the PHY hardware block; determine, using the PHY management application, attributes of the external PHY device; determine, using the PHY management application, configuration parameters for an Ethernet link based on the attributes of the PHY hardware block and the external PHY block; and send commands from the PHY management application via the set of APIs to direct the MAC firmware to configure the Ethernet link based on the configuration parameters.

Example 16 includes the subject matter of example 15, where the instructions are further executable to: receive, at the PHY management application, through the set of APIs, status information for the Ethernet link, where the status information includes information associated with the external PHY device.

Example 17 includes the subject matter of example 15, where the instructions are further executable to cause the machine to perform diagnostics, at the PHY management application, for the Ethernet link based on the status information.

Example 18 is a method including: loading a set of application programming interfaces (APIs) for management a physical layer of an Ethernet subsystem, where the Ethernet subsystem includes a local physical layer (PHY) hardware block to implement a port and a media access controller (MAC) block, where the MAC block includes MAC hardware and MAC firmware; loading a PHY management application in an application layer, where the PHY management application is to use the set of APIs; determining, using the PHY management application, that an external physical layer (PHY) device is coupled to the Ethernet subsystem; determining, using the PHY management application, capabilities of the PHY hardware block; determining, using the PHY management application, attributes of the external PHY device; determining, using the PHY management application, configuration parameters for an Ethernet link based on the attributes of the PHY hardware block and the external PHY block; and sending commands from the PHY management application via the set of APIs to direct the MAC firmware to configure the Ethernet link based on the configuration parameters.

Example 19 includes the subject matter of example 18, further including: receiving, at the PHY management application, through the set of APIs, status information for the Ethernet link, where the status information includes information associated with the external PHY device.

Example 20 includes the subject matter of example 18, further including performing diagnostics, at the PHY management application, for the Ethernet link based on the status information.

Example 21 is a system including means to perform the method of any one of examples 18-20.

Example 22 includes the subject matter of example 21, where the means include a non-transitory machine readable medium with instructions stored thereon, the instructions executable by a machine to cause the machine to perform the method of any one of examples 18-20

Example 23 is a system including: a host processor device including: a processor; an Ethernet subsystem including: a controller; physical layer (PHY) hardware to implement a port; an application layer including: a set of PHY management APIs to abstract details of the controller and PHY hardware; a PHY management application to call the set of PHY management APIs to direct one of firmware of the controller or firmware of the PHY hardware to configure a link to couple the port to a link partner device.

Example 24 includes the subject matter of example 23, where the external PHY device includes one of a retimer, media conversion device, or PHY device to support a particular port mode.

Example 25 includes the subject matter of example 23, where the PHY management application is to direct configuration of a local port implemented by the PHY hardware local port.

Example 26 includes the subject matter of any one of examples 23-25, further including: an external PHY device to couple to the port, where the external PHY device is to implement at least a segment of the link; a management interface device to couple the Ethernet subsystem to the external PHY device by a set of out-of-band control lanes, where the set of PHY management APIs enable the PHY management application to at least one of: receive information sent from the external PHY device on the set of control lanes; or send control information to the external PHY device on the set of control lanes.

Example 27 includes the subject matter of example 26, where the PHY management application is to identify attributes of an external PHY device coupled to the system by the local port, where the external PHY device facilitates a connection with a link partner device over the link and is positioned between the local port and the link partner device on the link.

Example 28 includes the subject matter of example 26, where the external PHY device includes a retimer.

Example 29 includes the subject matter of example 26, where the external PHY device includes a media module to transition from a first media used in a link segment to couple the local port to the external PHY device and a second media used in a second link segment to couple the external PHY device to the link partner device.

Example 30 includes the subject matter of example 26, where the external PHY device supports a particular port mode not supported by the PHY hardware and facilitates use of the particular port mode on the link.

Example 31 includes the subject matter of any one of examples 26-30, where the PHY management application directs configuration of the local port based on the attributes of the external PHY device.

Example 32 includes the subject matter of any one of examples 26-31, where the PHY management application is to further use the API to direct configuration of one or more ports of the external PHY device.

Example 33 includes the subject matter of any one of examples 26-32, where the attributes of the external PHY device include at least one of a type of the external PHY device, port modes supported by the external PHY device, or a media used by the external PHY device.

Example 34 includes the subject matter of any one of examples 26-33, where the PHY management application is further executable to: receive fault information for the link, where the fault information includes information associated with the external PHY device; and identify, from the fault information, a link segment of the link associated with the fault.

Example 35 includes the subject matter of any one of examples 24-34, where configuration of the physical layer of the link includes equalization of one or more ports used to establish the link.

Example 36 includes the subject matter of any one of examples 24-35, where the API is associated with a software development kit (SDK), and the PHY management application is written based on the SDK.

Example 37 includes the subject matter of example 36, where the SDK enables development of a plurality of different PHY management applications to interoperate with respective instances of the controller firmware.

Example 38 includes the subject matter of any one of examples 24-37, where the link is to be established based on an Ethernet-based protocol.

Example 39 is a method including: receiving, at a media access controller block of a device, a message from physical layer (PHY) management software via an application programming interface, where the media access controller block includes controller firmware and controller hardware, where the media access controller is to interface with PHY hardware of the device, and the PHY hardware is to implement at least a portion of a link; and directing the PHY hardware, via firmware of the media access controller block, to configure the physical layer of the link based on the message from the PHY management software.

Example 40 includes the subject matter of example 39, where configuration of the physical layer of the link includes equalization of one or more ports used to establish the link.

Example 41 includes the subject matter of any one of examples 39-40, where the API is associated with a software development kit (SDK), and the PHY management software is based on the SDK.

Example 42 includes the subject matter of example 41, where the SDK enables development of a plurality of different PHY management applications to interoperate with respective instances of the controller firmware.

Example 43 includes the subject matter of any one of examples 39-42, where the link is to be established based on an Ethernet-based protocol.

Example 44 includes the subject matter of any one of examples 39-43, where the firmware of the media access controller block directs configuration of the physical layer through communications with firmware of the PHY hardware.

Example 45 is a system including means to perform the method of any one of examples 39-44.

Example 46 includes the subject matter of example 45, where the means include a non-transitory machine readable medium with instructions stored thereon, the instructions executable by a machine to cause the machine to perform the method of any one of examples 39-44.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a processor;
physical layer (PHY) hardware, wherein the physical layer hardware comprises circuitry to implement at least a portion of a link;
receive, at a media access controller block, a message via an application programming interface, from software wherein the media access controller block comprises controller firmware and controller hardware, wherein the controller hardware is to interface with the PHY hardware to establish the link; and
PHY management software, executable by the processor, to configure a physical layer of the link, wherein the PHY management software is to call on an application programming interface (API) to send commands to the controller firmware and direct configuration of the physical layer of the link via the controller firmware, wherein the API abstracts functions of the controller firmware to be used to configure the physical layer of the link.

2. The apparatus of claim 1, wherein the PHY management software is to direct configuration of a local port implemented by the PHY hardware local port.

3. The apparatus of claim 2, wherein the PHY management software is to identify attributes of an external PHY device coupled to the apparatus by the local port, wherein the external PHY device facilitates a connection with a link partner device over the link and is positioned between the local port and the link partner device on the link.

4. The apparatus of claim 3, wherein the external PHY device comprises a retimer.

5. The apparatus of claim 3, wherein the external PHY device comprises a media module to transition from a first media used in a link segment to couple the local port to the external PHY device and a second media used in a second link segment to couple the external PHY device to the link partner device.

6. The apparatus of claim 3, wherein the external PHY device supports a particular port mode not supported by the PHY hardware and facilitates use of the particular port mode on the link.

7. The apparatus of claim 3, wherein the PHY management software directs configuration of the local port based on the attributes of the external PHY device.

8. The apparatus of claim 3, wherein the PHY management software is to further use the API to direct configuration of one or more ports of the external PHY device.

9. The apparatus of claim 3, wherein the attributes of the external PHY device comprise at least one of a type of the external PHY device, port modes supported by the external PHY device, or a media used by the external PHY device.

10. The apparatus of claim 3, wherein the PHY management application is further executable to:
receive fault information for the link, wherein the fault information comprises information associated with the external PHY device;
identify, from the fault information, a link segment of the link associated with the fault.

11. The apparatus of claim 1, wherein configuration of the physical layer of the link comprises equalization of one or more ports used to establish the link.

12. The apparatus of claim 1, wherein the API is associated with a software development kit (SDK), and the PHY management application is written based on the SDK.

13. The apparatus of claim 12, wherein the SDK enables development of a plurality of different PHY management applications to interoperate with respective instances of the controller firmware.

14. The apparatus of claim 1, wherein the link is to be established based on an Ethernet-based protocol.

15. At least one non-transitory machine readable medium with instructions stored thereon, the instructions executable by a machine to cause the machine to:
load a set of application programming interfaces (APIs) for management of a physical layer of an Ethernet subsystem, wherein the Ethernet subsystem comprises a local physical layer (PHY) hardware block to implement a port and a media access controller (MAC) block, wherein the MAC block comprises MAC hardware and MAC firmware;
load a PHY management application in an application layer, wherein the PHY management application is to use the set of APIs;
determine, using the PHY management application, that an external physical layer (PHY) device is coupled to the Ethernet subsystem;
determine, using the PHY management application, capabilities of the PHY hardware block;
determine, using the PHY management application, attributes of the external PHY device;
determine, using the PHY management application, configuration parameters for an Ethernet link based on the attributes of the PHY hardware block and the external PHY block;
send commands from the PHY management application via the set of APIs to direct the MAC firmware to configure the Ethernet link based on the configuration parameters.

16. The storage medium of claim 15, wherein the instructions are further executable to:
receive, at the PHY management application, through the set of APIs, status information for the Ethernet link, wherein the status information comprises information associated with the external PHY device.

17. The storage medium of claim 15, wherein the instructions are further executable to cause the machine to perform diagnostics, at the PHY management application, for the Ethernet link based on the status information.

18. A system comprising:
a host processor device comprising:
a processor;
an Ethernet subsystem comprising:
a controller;
physical layer (PHY) hardware to implement a port;
an application layer comprising:
a set of PHY management APIs to abstract details of the controller and PHY hardware;
a PHY management application to call the set of PHY management APIs to direct one of firmware of the controller or firmware of the PHY hardware to configure a link to couple the port to a link partner device.

19. The system of claim 18, further comprising:
an external PHY device to couple to the port, wherein the external PHY device is to implement at least a segment of the link;
a management interface device to couple the Ethernet subsystem to the external PHY device by a set of out-of-band control lanes, wherein the set of PHY management APIs enable the PHY management application to at least one of:
receive information sent from the external PHY device on the set of control lanes; or
send control information to the external PHY device on the set of control lanes.

20. The system of claim 18, wherein the external PHY device comprises one of a retimer, media conversion device, or PHY device to support a particular port mode.
